(19) United States
(12) Patent Application Publication
(10) Pub. No.: US 2009/0141327 A1
(43) Pub. Date: Jun. 4, 2009

(54) System and Method for Dynamic Display System Illumination

(76) Inventors: Steven Monroe Penn, Plano, TX (US); Carl W. Davis, Plano, TX (US)

Correspondence Address: TEXAS INSTRUMENTS INCORPORATED, P O BOX 655474, M/S 3999, DALLAS, TX, 75265, US

(21) Appl. No.: 11/949,624

(22) Filed: Dec. 3, 2007

(51) Int. Cl. G02B 26/12; G02B 26/08; G02F 1/33; G02B 26/10

(52) U.S. Cl. 359/201.1; 359/238; 359/298; 359/305

(57) ABSTRACT

A system and method for increasing display brightness in laser illuminated display systems. An illumination source comprises a light source to produce colored light and a scanning optics unit optically coupled to the light source. The scanning optics unit scans the colored light along a direction orthogonal to a light path of the illumination source. The scanning optics unit comprises a diffuser to transform the colored light in beams of colored light, a scan optics element positioned in the light path after the diffuser, the scan optics element to move beams of colored light in a direction orthogonal to the light path with distinct beams of colored light separated by unilluminated space, and a lens element positioned in the light path after the scan optics element, the lens element to convert an angular refraction of the beams of colored light into a spatial deflection.

### CROSS-REFERENCE TO RELATED APPLICATIONS

This application is related to the following co-assigned patent applications: Ser. No. 11/693,343, filed Mar. 29, 2007, entitled “Optical System for a Thin, Low-Chin, Projection Television,” Ser. No. 11/848,022, filed Aug. 30, 2007, entitled “System and Method for Display Illumination,” and Ser. No. ______ (Attorney Docket No. TI-64970), filed ______, entitled “Optical System for a Thin, Low-Chin, Projection Television,” which applications are hereby incorporated herein by reference.

### TECHNICAL FIELD

The present invention relates generally to a system and method for displaying images, and more particularly to a system and method for increasing display brightness in laser illuminated display systems.

### BACKGROUND

In a microdisplay-based projection display system, light from a light source may be modulated by the microdisplay as the light reflects off the surface of the microdisplay or passes through the microdisplay. Examples of commonly used microdisplays may include digital micromirror devices (DMD), deformable micromirror devices, transmissive or reflective liquid crystal, liquid crystal on silicon, ferroelectric liquid crystal on silicon, and so forth. In a digital micromirror device (DMD)-based projection system, where large numbers of positional micromirrors may change state (position) depending on an image being displayed, light from the light source may be reflected onto or away from a display plane.

Generally, a microdisplay may be illuminated by a light source having a high etendue (such as an electric arc lamp or an ultra-high pressure arc lamp, for example) or a low etendue (for example, a laser or a solid-state light source). FIG. 1a illustrates a portion of a microdisplay-based projection display system 100. The microdisplay-based projection display system 100 includes a light source 105 and a microdisplay 110. The light source 105 may be used to provide light that illuminates the microdisplay 110.

Usually, when illuminated using a high etendue light source, the illumination may make use of a technique commonly referred to as sequential color or field sequential color, wherein the microdisplay 110 is illuminated by a sequence of colored light, one color after the other. For example, the light source 105 produces light, one color at a time, to illuminate the microdisplay 110. Alternatively, a filter positioned in a light path between the light source 105 and the microdisplay 110 may filter out unwanted colors of light while passing a desired color of light to illuminate the microdisplay 110. The filter may be designed so that a color of light that it passes changes with time. A rotating color wheel may be an example of the filter.

FIG. 1b illustrates a light output from the light source 105 operating in sequential color mode. The light source 105 produces a first color “color 1” 130 for a period of time, followed by a second color “color 2” 135 and a third color “color 3” 140, and so on. Other variations of sequential color mode may be source overlap and source desaturation.

FIG. 1c illustrates a light output from the light source 105 operating in source overlap sequential color mode. In source overlap sequential color mode, the light source 105 may combine two or more primary colors, such as red, green, and blue, to produce a multi-primary color. For example, the light source 105 may combine the first color 130 and the second color 135 to produce multi-primary color 145. If the first color 130 is red and the second color 135 is blue, then the multi-primary color 145 is magenta. Similarly, multi-primary color 150 may be created from the second color 135 and the third color 140, while the third color 140 and the first color 130 may create multi-primary 155.

FIG. 1d illustrates a light output from the light source 105 operating in source desaturation sequential color mode. In source desaturation sequential color mode, desaturated versions of primary colors, such as red, green, and blue, may be displayed in conjunction with small amounts of fully saturated versions of the other primary colors. For example, a desaturated first color “desat color 1” 160 may be outputted from the light source 105 at the same time as small amounts of fully saturated versions of a second primary color “desat color 2” 165 (shown as block 167) and a third primary color “desat color 3” 170 (shown as block 172).

Using sequential color illumination techniques with low etendue light sources may require low-duty, pulsed operation. This, for laser light sources, may cause instability and inefficiency, since many forms of laser light sources perform near optimally when operated at near 100 percent duty cycle. Therefore, there is a need for an illumination technique that increases the duty cycle of a light source in laser illuminated display systems.

### SUMMARY OF THE INVENTION

These and other problems are generally solved or circumvented, and technical advantages are generally achieved, by embodiments of a system and a method for increasing display brightness in laser illuminated display systems.

In accordance with an embodiment, an illumination source is provided. The illumination source includes a light source to produce colored light, and a scanning optics unit optically coupled to the light source, the scanning optics unit scans the colored light along a direction orthogonal to a light path of the illumination source. The scanning optics unit includes a diffuser to transform the colored light into beams of colored light, a scan optics element positioned in the light path after the diffuser, the scan optics element to move the beams of colored light in the direction orthogonal to the light path, where distinct beams of colored light are separated by unilluminated space, and a lens element positioned in the light path after the scan optics element, the lens element converts an angular refraction of the beams of colored light into a spatial deflection.

In accordance with another embodiment, a display system is provided. The display system includes an illumination source, a microdisplay optically coupled to the illumination source and positioned in a light path of the illumination source after the illumination source, and a controller electronically coupled to the microdisplay and to the illumination source. The illumination source includes a light source to produce colored light, and a scanning optics unit optically coupled to the light source, the scanning optics unit scans the colored light along a direction orthogonal to a light path of the illumination source. The scanning optics unit includes a diffuser to transform the colored light into beams of colored light, a scan optics element positioned in the light path after the diffuser, the scan optics element to move the beams of colored light in the direction orthogonal to the light path, where distinct beams of colored light are separated by unilluminated space, and a lens element positioned in the light path after the scan optics element, the lens element to convert an angular refraction of the beams of colored light into a spatial deflection. The microdisplay produces images by modulating light from the illumination source based on image data, and the controller controls the scanning of the colored light, and loads image data into the microdisplay based on a position of the beams of colored light.

In accordance with another embodiment, a method of manufacturing a display system is provided. The method includes installing a light source to generate coherent light, installing a microdisplay in a light path of the display system after the light source, installing a controller to control the light source, the scan optics element, and the microdisplay, and installing a display plane in the light path of the display system after the microdisplay. The light source installing includes installing a coherent light source to produce beams of colored light, installing a diffuser in a light path of the coherent light source, installing a scan optics element having facets arranged along an edge of the scan optics element in the light path of the coherent light source after the diffuser so that the light path of the coherent light source is incident to the edge and is orthogonal to the edge, the scan optics element to scan the beams of colored light with unilluminated space separating the beams of colored light, installing a motor to rotate the scan optics element, and installing a lens element in the light path after the scan optics element.

In accordance with another embodiment, an illumination source is provided. The illumination source includes a light source to produce colored light, and a scanning optics unit optically coupled to the light source. The scanning optics unit scans the colored light along a direction orthogonal to a light path of the illumination source. The scanning optics unit includes a diffuser to transform the colored light into beams of colored light, a scan optics element positioned in the light path after the diffuser, the scan optics element moves the beams of colored light in the direction orthogonal to the light path responsive to a modulated signal, and a lens element positioned in the light path after the scan optics element, the lens element converts an angular refraction of the beams of colored light into a spatial deflection.

An advantage of an embodiment is that image brightness may be increased, and as a result, image quality may be improved. This may be achieved by operating laser light sources at near 100 percent duty cycle. Furthermore, when operating at near 100 percent duty cycle, many laser light sources operate at better reliability, color stability, and efficiency.

A further advantage of an embodiment is that low etendue light sources may enable the use of low etendue color filters, microdisplays, lens, and so forth. Therefore, overall product size, cost, and illumination efficiency may be achieved.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a portion of a microdisplay-based projection display system;

FIGS. 1b through 1d are diagrams of light output from a light source operating in sequential color mode;

FIG. 2a is a diagram of a DMD-based projection display system;

FIG. 2b is a diagram of light beams scanned over the surface of a DMD;

FIG. 2c is a diagram of a scanning optics unit;

FIG. 2d is a diagram of a controller;

FIG. 3 is a diagram of a portion of a DMD-based projection display system;

FIG. 4 is a diagram of a portion of a DMD-based projection display system;

FIGS. 5a through 51 are diagrams of light intensity for a variety of modulated light produced by a light source;

FIG. 6 is a diagram of a portion of a DMD-based projection display system;

FIG. 7 is a diagram of a portion of a DMD-based projection display system;

FIG. 8 is a diagram of a sequence of events in the manufacture of a microdisplay-based projection display system;

FIGS. 9a and 9b are diagrams of a portion of a DMD-based projection display system; and

FIGS. 10a and 10b are diagrams of a portion of a DMD-based projection display system.

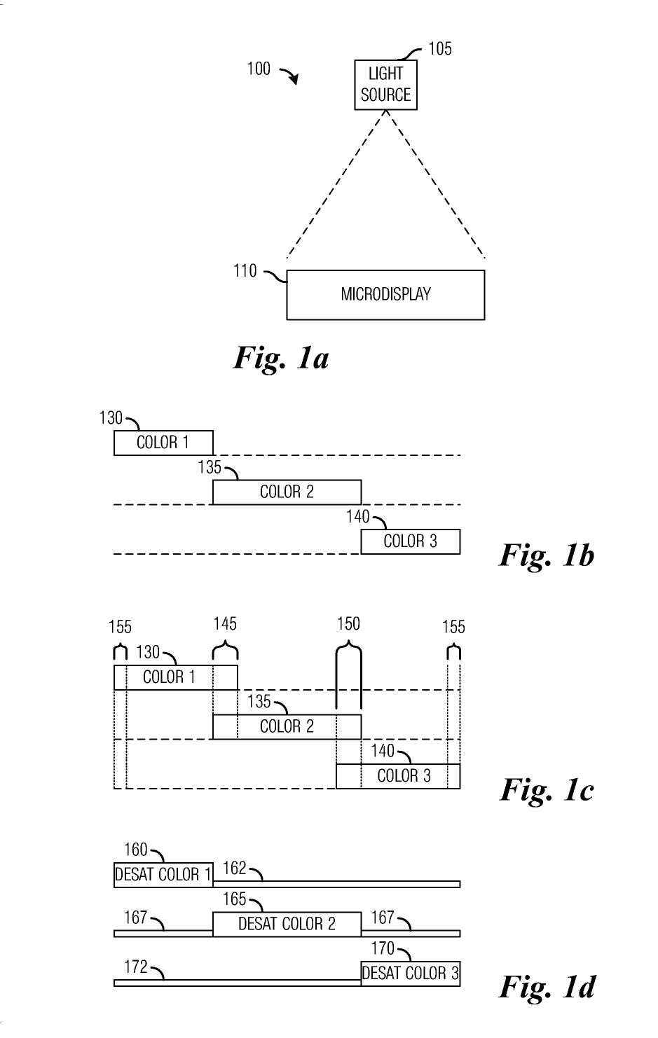

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a laser illuminated, microdisplay-based projection display system, wherein the microdisplay is a DMD. The invention may also be applied, however, to other laser illuminated, microdisplay-based projection display systems, such as projection display systems utilizing deformable micromirror devices, transmissive or reflective liquid crystal displays, liquid crystal on silicon displays, ferroelectric liquid crystal on silicon displays, and so forth.

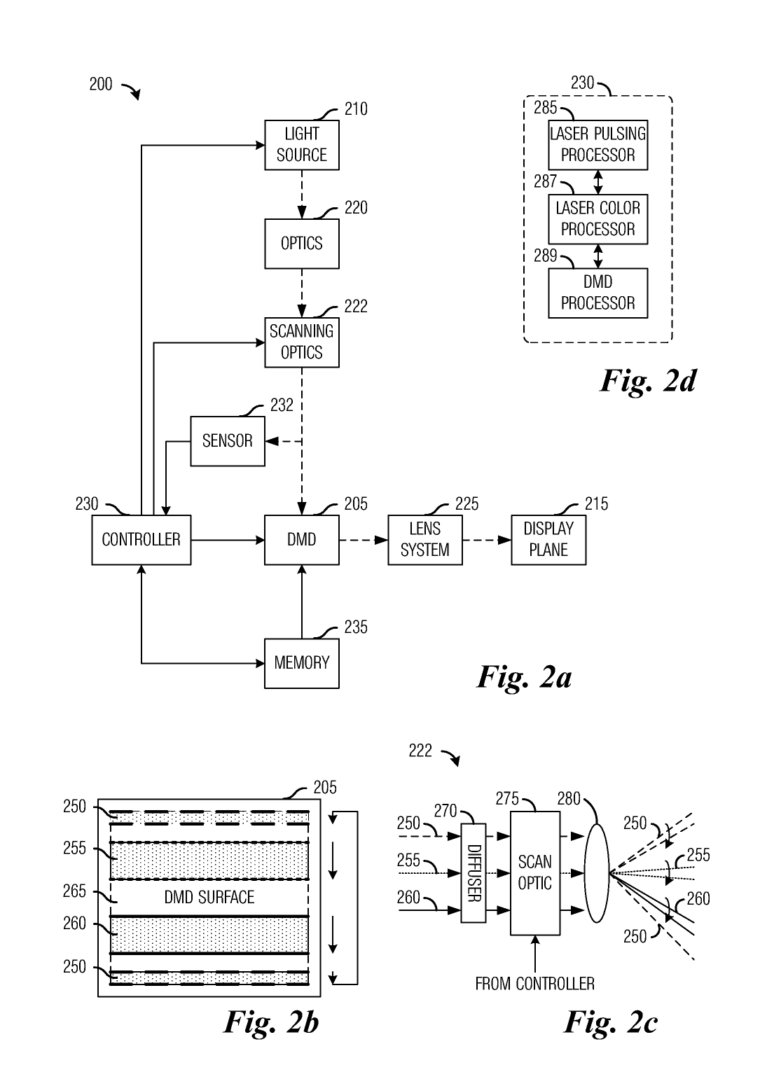

With reference now to FIG. 2a, there is shown a diagram illustrating a laser illuminated DMD-based projection display system 200. The DMD-based projection display system 200 includes a DMD 205 that modulates light produced by a light source 210. The light source 210 may make use of multiple lasers to produce the desired colors of light. Although the discussion focuses on solid-state lasers, other sources of light, including filtered non-coherent light, free-electron lasers, and so forth, may be used in place of the solid-state lasers. Therefore, the discussion should not be construed as being limiting to the present embodiments.

The DMD 205 is an example of a microdisplay or an array of light modulators. Other examples of microdisplays may include transmissive or reflective liquid crystal, liquid crystal on silicon, ferroelectric liquid-crystal-on-silicon, deformable micromirrors, and so forth. In a microdisplay, a number of light modulators may be arranged in a rectangular, square, diamond shaped, and so forth, array. Each light modulator in the microdisplay may operate in conjunction with the other light modulators in the microdisplay to modulate the light produced by the light source 210. The light modulated by the DMD 205 may be used to create images on a display plane 215. The DMD-based projection display system 200 also includes an optics system 220, which may be used to collimate the light produced by the light source 210 as well as to collect stray light. The DMD-based projection display system 200 may also include a lens system 225, which may be used to manipulate (for example, focus) the light reflecting off the DMD 205.

The DMD-based projection display system 200 may also include a scanning optics unit 222 in its optical path. The scanning optics unit 222 may be used to scan light from the light source 210 over a surface of the DMD 205. The scanning optics unit 222 may allow for the simultaneous illumination of the DMD 205 with light of different colors. FIG. 2b illustrates a top view of the surface of the DMD 205. Shown in the surface of the DMD 205 may be several beams of different colored light, for example, a red colored light (shown as dashed light beam 250) may illuminate a top portion of the surface of the DMD 205, while a green colored light (shown as dotted light beam 255) may illuminate a middle portion of the surface of the DMD 205, and a blue colored light (shown as solid light beam 260) may illuminate a bottom-middle portion of the surface of the DMD 205. Furthermore, a bottom portion of the surface of the DMD 205 is illuminated by a part of the dashed light beam 250, representing the red colored light. As the red colored light moves off the bottom portion of the surface of the DMD 205, it reappears at the top portion of the surface of the DMD 205.

The light beams as created by the scanning optics unit 222 preferably occupy a portion of the surface of the DMD 205 that is less than a reciprocal of the number of light beams. For example, if there are three light beams illuminating the surface of the DMD 205, the light beams preferably have a thickness of less than ⅓^{rd} of the surface of the DMD 205. Therefore, there may be portions of the surface of the DMD 205 that are unilluminated between the light beams. For example, a portion 265 of the surface of the DMD 205 is unilluminated by light from the light source 210. The unilluminated portions of the surface of the DMD 205 may allow for the loading of image data into the light modulators of the DMD 205. Furthermore, the unilluminated portions of the surface of the DMD 205 may allow for altering the scan rate of individual colors of light without causing interference with other colors of light.

The simultaneous illumination of the surface of the DMD 205 with light of different colors may enable a higher duty cycle for the laser light sources in the light source 210, thereby increasing the brightness of the images produced by the DMD-based projection display system 200. Furthermore, by increasing the duty cycle of the laser light sources, the laser light sources may be operating more efficiently, with better reliability, and with greater color stability. FIG. 2c illustrates a detailed view of the scanning optics unit 222. The scanning optics unit 222 includes a diffuser 270, a scan optic element 275, and an optical element 280. The diffuser 270, such as a light-shaping diffuser, may be used to generate light bands from the light from the light source 210, which may typically be in the form of a light spot. Additionally, the diffuser 270 may also be used to generate a light beam having an intensity that varies from a leading edge to a trailing edge. The scan optic element 275 may be used to scan individual light from the light source 210 over the surface of the DMD 205. The optical element 280 may be used to convert angular refraction into spatial deflection, correct for a defocusing of individual beams of light, correct for a non-linearity of the scanning, and so forth. Examples of the optical element 280 may be an F-theta lens, a mirrored surface, and/or a relay lens. An F-theta lens may be a combination of two lenses, a divergent lens and a convergent lens.

The scan optic element 275 may scan light from the light source 210 at a substantially constant rate over the surface of the DMD 205. Alternatively, the scanning rate of the light from the light source 210 may be changed as needed to alter the dynamic range of the light. For example, the scanning rate may be increased to decrease light dwell time, effectively decreasing the amount of light incident on the surface of the DMD 205, thereby decreasing the amount of light reflected onto the display plane 215. Furthermore, the scanning rate of the light from the light source 210 may be varied on an individual basis, with each color of light potentially having a different scanning rate over the surface of the DMD 205. A more detailed discussion of the scanning optics unit 222 and the scan optic element 275 is provided below.

Turning back now to FIG. 2a, the DMD 205 may be coupled to a controller 230, which may be responsible for loading image data into the DMD 205, controlling the operation of the DMD 205, providing micromirror control commands to the DMD 205, controlling the light produced by the light source 210, and so forth. A memory 235, which may be coupled to the DMD 205 and the controller 230, may be used to store the image data, as well as configuration data, color correction data, and so forth.

FIG. 2d illustrates a detailed view of the controller 230. The controller 230 includes a laser pulsing processor 285, a laser color processor 287, and a DMD processor 289. The laser pulsing processor 285 may be used to control real-time laser intensity and pulsing of the laser in the light source 210. Additionally, the laser pulsing processor 285 may be used for laser interlock. The laser color processor 287 may be used for white-point control, temperature control, as well as calibration of the lasers in the light source 210. Furthermore, the laser color processor 287 may be used in conjunction with the laser pulsing processor 285 in laser interlock. The DMD processor 289 may be used to control the operation of the DMD 205 as well as implementing techniques for improving image quality, such as enhancing brightness, image dynamic range, and so on. The DMD processor 289 may also be used to implement multi-view images as well as three-dimensional images. The controller 230 may be a single controller or multiple controllers.

Turning back now to FIG. 2a, a sensor 232 may be used to provide information related to the light produced by light source 210 and the scanning optics unit 222 to the controller 230, which may make use of the information to control the operation of the light source 210 and the scanning optics unit 222. The sensor 222 may be located in the optical path of the DMD-based projection display system 200 and directly convert light in the optical path into electrical information. Alternatively, an optical element, such as a neutral density filter, a coated or uncoated piece of glass, a mirror, or so forth, may be used to sample a fraction of the light in the optical path of the DMD-based projection display system 200 and direct the sample to the sensor 222.

The sensor 232 may be an opto-electric sensor, such as a charge-coupled device (CCD), CMOS optical sensor, and so forth, capable of converting light incident on its surface into electrical information, which may be processed by the controller 230. The controller 230 may make use of the electrical information to ensure that the light source 210 is producing light at desired color points, for desired durations, and so on. Additionally, the controller 230 may use the electrical information to determine if the scanning optics unit 222 is moving the light over the surface of the DMD 205 at the proper rate with proper spacing between the different colors of light, and so forth.

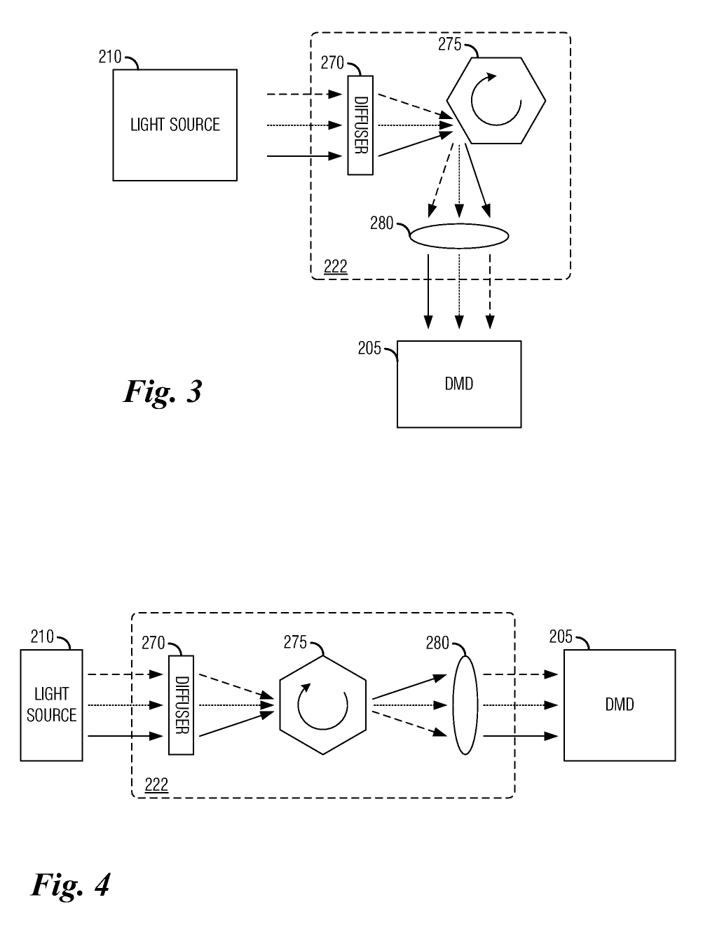

FIG. 3 illustrates a detailed view of a scanning optics unit 222, wherein a reflective surface may be used to scan light from the light source 210 over the surface of the DMD 205. The scanning optics unit 222 includes the diffuser 270, the scan optics element 275, and the optical element 280 as discussed previously. The scan optics element 275 comprises a rotating entity having reflective surfaces, such as a polygon mirror. A polygon mirror may be a cylindrical-shaped disk with flat or relatively flat surfaces or face arranged on an outer edge of the disk so that the flat surfaces are parallel with a rotational axis running through a center of the disk. Each flat surface on the edge of the disk being a mirror surface.

The scan optics element 275 may be rotated by an electric motor and as the scan optics element 275 rotates around the rotational axis, the individual mirrored surfaces move the individual colored light beams across the surface of the DMD 205. The rotational axis may be orthogonal to the light path of the DMD-based projection display system 200 as well as a direction of the scanning of the light. The scan optics element 275 preferably has a large number of reflective surfaces, such as four or more, or as shown in FIG. 3, six reflective surfaces. The higher the number of reflective surfaces will mean that the scan optics element 275 will not have to be rotated as rapidly as a similar scan optics element with a lower number of reflective surfaces. A lower rate of rotation may allow for the use of a less expensive motor and may produce less noise and vibration and may consume less power due to the slower rotation rate.

Furthermore, the rate of rotation of the scan optics element 275 may be altered to produce different light scan rates. For example, by increasing the rate of rotation, the light scan rates may be increased, while the light scan rate may be decreased by decreasing the rate of rotation of the scan optics element 275. Since there is a single scan optics element 275, changes to the rate of rotation affects each of the different lights equally.

FIG. 4 illustrates a detailed view of a scanning optics unit 222, wherein a refractive body may be used to scan light from the light source 210 over the surface of the DMD 205. Unlike the reflective surface used in the scan optics element 275 shown in FIG. 3, the scan optics element 275 shown in FIG. 4 uses a refractive body, such as a faceted prism or a diffractive optical element, to scan the light from the light source over the surface of the DMD 205. Similar to the polygon mirror, the faceted prism or diffractive optical element may have the appearance of a disk with multiple flat or substantially flat surfaces arrange on its edge. The faceted prism or diffractive optical element may be coated with an antireflective coating to help reduce light loss due to reflection. The faceted prism or diffractive optical element, however, permits light to pass through rather than reflecting the light and bends the light as it passes through, scanning the light across the surface of the DMD 205. As with the reflective surface scanning optics unit, the scan optics element 275 preferably has a large number of facets.

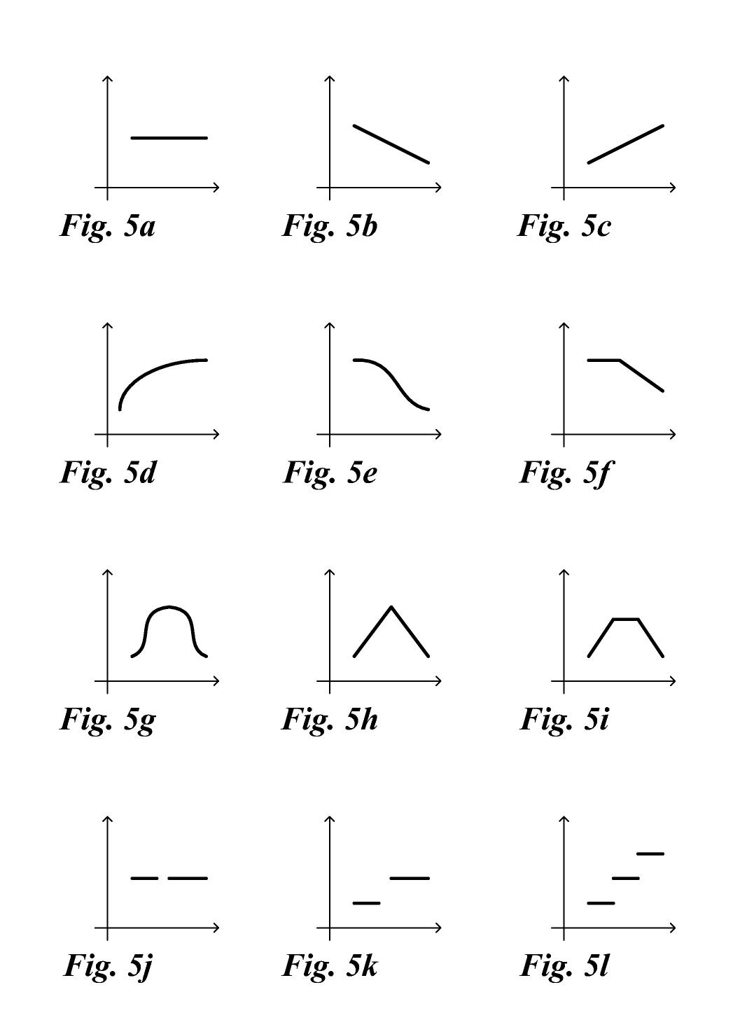

In addition to altering the scanning rate, the light from the light source 210 may be modulated or otherwise changed over time to help increase the dynamic range of the DMD-based projection display system 200. For example, the intensity of the light from the light source 210 may be increased or decreased to increase the dynamic range by increasing a brightest displayable shade or decrease a dimmest displayable shade of a color. FIGS. 5a through 51 display plots of light intensity for light from the light source 210, wherein the diagrams display light intensity of a cross section of a light beam produced by the light source 210. FIGS. 5a through 51 illustrate light intensity diagrams for several modulated light beams. The figures are for illustrative purposes and are not meant to be an exhaustive list. Therefore, the discussion of the figures is not intended to be limiting to either the scope or the spirit of the embodiments.

FIG. 5a illustrates a light intensity plot for a light beam having constant light intensity. FIG. 5b illustrates a light intensity plot for a light beam having a linearly decreasing light intensity, while FIG. 5c illustrates a light intensity plot for a light beam having a linearly increasing light intensity. Changes in light intensity do not need to be linear, and FIGS. 5d and 5e illustrate a light intensity plots for light beams having non-linear changes in light intensity. Additionally, light intensity may remain constant for a period of time before changing, such as shown in FIG. 5f. Furthermore, the light intensity changes in a light beam may increase and decrease, such as shown in FIGS. 5g through 5i, wherein the light intensity increases and then decreases. The light intensity changes may also be non-continuous. FIGS. 5j through 51 illustrate light intensity changing in a step-wise manner.

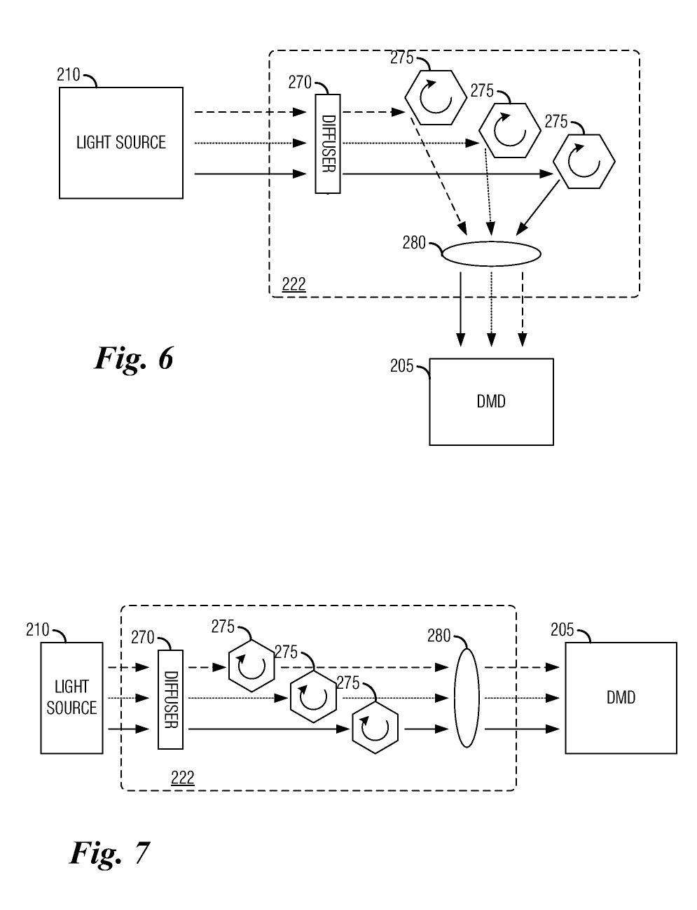

In addition to collectively changing the scan rate of the light from the light source 210, the scan rate of individual light beams may be changed. FIG. 6 illustrates a detailed view of a scanning optics unit 222, wherein multiple reflective surfaces may be used to scan light from the light source 210 over the surface of the DMD 205. The scanning optics unit 222 may include multiple scan optics elements 275, one for each individual color of light, for example. Alternatively, there may be one scan optics element 275 for each color of light that may be simultaneously incident on the surface of the DMD 205. For example, if the light source 210 may produce seven (7) different colors of light, but only three different colors of light may be simultaneously incident on the surface of the DMD 205 at any given time, then there may only be a need for three scan optics elements 275.

Each scan optics element 275 may be rotated at a different rate to impart a different scan rate to each color of light. Additional control may be needed to ensure that one color of light does not superimpose itself on a different color of light, for example. However, in certain applications, it may be useful to purposely superimpose different colors of light to create a color of light not ordinarily producible by the light source 210. For example, multiple primary colors may be superimposed to create a secondary color of light or a white light.

An application of individual scan rates for different colors of light may be to enhance a dynamic range of the DMD-based projection display system 200 by rapidly (or slowly) scanning a color of light over the surface of the DMD 205 while keeping scan rates for other colors of light relatively constant. Each scan optics element 275 may be identical, having the same general physical characteristics, such as shape, size, number of facets, and so forth. Alternatively, some or all scan optics element 275 may have different physical characteristics, such as different sizes, numbers of facets, and so on.

FIG. 7 illustrates a detailed view of a scanning optics unit 222, wherein multiple refractive bodies may be used to scan light from the light source 210 over the surface of the DMD 205. FIG. 7 illustrates a scanning optics unit 222 using multiple refractive bodies, such as faceted prisms or diffractive optical elements, to enable different scan rates for different colors of light. As with the scanning optics unit 222 shown in FIG. 6, the scanning optics unit 222 may have scan optics elements that are about identical, having the same general physical characteristics, such as shape, size, number of facets, and so forth. Alternatively, some or all scan optics element 275 may have different physical characteristics, such as different sizes, numbers of facets, and so on.

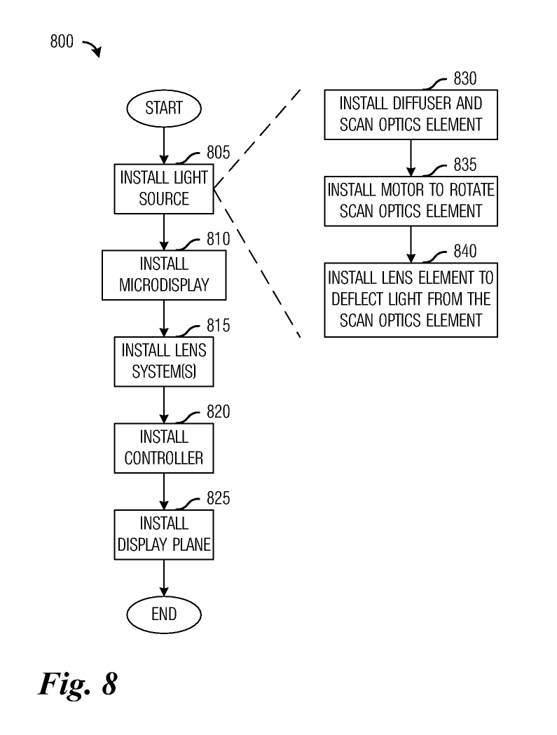

FIG. 8 illustrates a sequence of events 800 in the manufacture of an exemplary microdisplay-based projection display system. The manufacture of the microdisplay-based projection display system may begin with installing a light source, which may produce multiple colors of light (block 805). The installing of the light source may include the installing of a diffuser and a scan optics element (block 830). Also installed may be a motor to rotate the scan optics element (block 835). Furthermore, a lens (lenses) element may then be installed to deflect the light scanned by the scan optics element (block 840).

The manufacture may continue with installing a microdisplay, such as a DMD, in the light path of the multiple colors of light produced by the light source (block 810). After installing the microdisplay, a lens system may be installed in between the light source and the microdisplay (block 815). A controller for the microdisplay-based projection display system may then be installed (block 820). With the controller installed, the manufacture may continue with installing a display plane (block 825). The order of the events in this sequence may be changed, the sequence may be performed in a different order, or some of the steps may be performed at the same time to meet particular manufacturing requirements of the various embodiments of the DMD, for example.

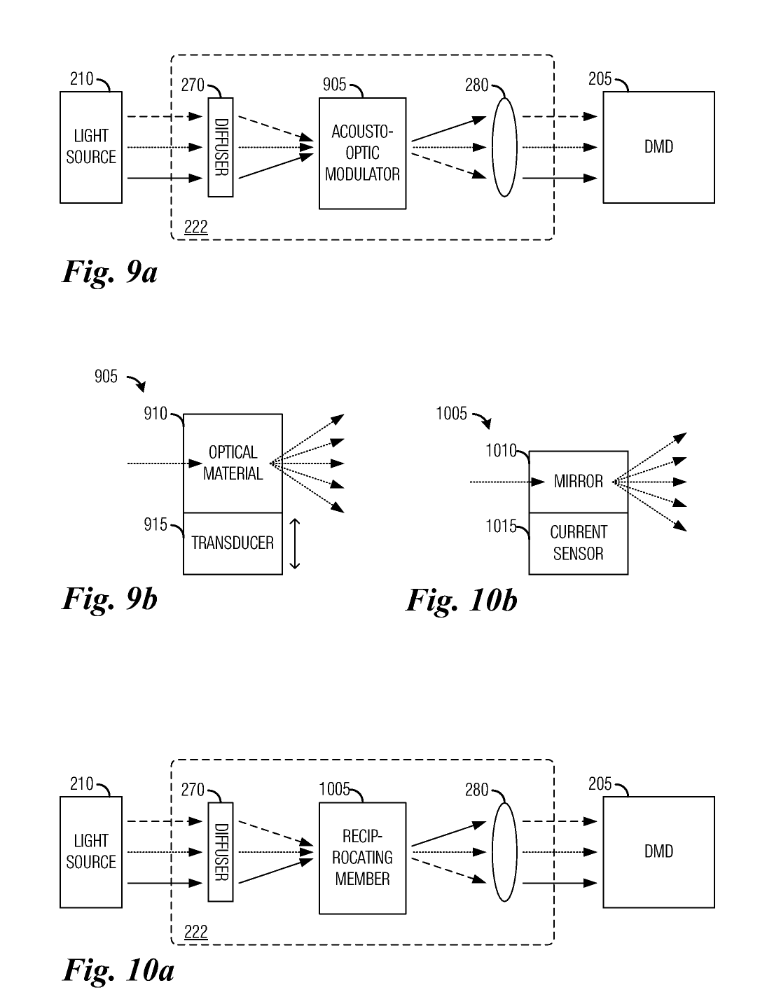

FIG. 9a illustrates a detailed view of a scanning optics unit 222, wherein an acousto-optic modulator 905 may be used to scan light from the light source 210 over the surface of the DMD 205. The acousto-optic modulator 905 may make use of an acousto-optic effect, wherein a change in a material's permittivity is realized by applying a mechanical strain, to diffract light. The mechanical strain may be applied to the material by sound waves. A Bragg cell is a common name for an acousto-optic modulator.

FIG. 9b illustrates a detailed view of the acousto-optic modulator 905. The acousto-optic modulator 905 includes an optical material 910 through which light passes and a transducer 915. The optical material 910 may be made from materials such as glass, quartz, plastic, and so forth. The transducer 915, such as a Piezo-electric transducer, may be used to create sound waves in the optical material 910. By varying the frequency of the sound waves, the diffracted light beam may emerge from the optical material 910 at an angle that is dependent on both the wavelengths of the light beam and the sound wave.

FIG. 10a illustrates a detailed view of a scanning optics unit 222, wherein a reciprocating member 1005 may be used to scan light from the light source 210 over the surface of the DMD 205. The reciprocating member 1005, such as a galvanometer mirror, may move a mirror in response to an electric current. The mirror may then scan the light from the light source 210 over the surface of the DMD 205.

FIG. 10b illustrates a detailed view of the reciprocating member 1005. The reciprocating member 1005 includes a mirror 1010 and a current sensor 1015. The current sensor 1015 may then move the mirror 1010 dependent on a sensed current, which may result in a scanning of the light over the surface of the DMD 205. The angle of the light reflected off the mirror 1010 may be dependent on the sensed current's magnitude and frequency, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An illumination source comprising:
a light source to produce colored light; and
a scanning optics unit optically coupled to the light source, the scanning optics unit configured to scan the colored light along a direction orthogonal to a light path of the illumination source, the scanning optics unit comprising
a diffuser to transform the colored light into beams of colored light,
a scan optics element positioned in the light path after the diffuser, the scan optics element to move the beams of colored light in the direction orthogonal to the light path, wherein distinct beams of colored light are separated by unilluminated space, and
a lens element positioned in the light path after the scan optics element, the lens element to convert an angular refraction of the beams of colored light into a spatial deflection.

2. The illumination source of claim 1, wherein the scan optics element rotates about an axis of rotation and the axis of rotation is orthogonal to the light path.

3. The illumination source of claim 1, wherein the light source produces light having a modulated intensity.

4. The illumination source of claim 1, wherein the scan optics element comprises a cylindrical-shaped body having a plurality of facets arranged about an outer edge of the body.

5. The illumination source of claim 4, wherein each facet of the cylindrical-shaped body is reflective.

6. The illumination source of claim 1, wherein the scan optics element is a refractive body.

7. The illumination source of claim 6, wherein the refractive body comprises a faceted prism or a diffractive optical element.

8. The illumination source of claim 1, wherein the scan optics element comprises a faceted optics element having four or more facets.

9. The illumination source of claim 1, wherein the scan optics element comprises a plurality of scan optics element, one scan optics element for each color of light the light source is capable of simultaneously producing.

10. The illumination source of claim 9, wherein all scan optics elements move beams of colored light at substantially the same rate.

11. The illumination source of claim 9, wherein each scan optics element is capable of moving a beam of colored light at a different rate.

12. The illumination source of claim 1, wherein the diffuser comprises a light-shaping diffuser.

13. The illumination source of claim 1, wherein the lens element comprises a relay lens, an F-theta lens, or a contoured mirror.

14. The illumination source of claim 1, wherein the scan optics element comprises an acousto-optic modulator or a reciprocating member.

15. The illumination source of claim 14, wherein the acousto-optic modulator comprises:
an optical material having an optical permittivity that changes with applied mechanical stress, the optical material positioned in the light path after the diffuser; and
a transducer coupled to the optical material, the transducer to convert electrical energy from the modulated signal into acoustical energy and to apply the acoustical energy to the optical material.

16. The illumination source of claim 14, wherein the reciprocating member comprises:
a mirror positioned in the light path after the diffuser; and
a current sensor coupled to the mirror, the current sensor to move the mirror based on a current sensed from the modulated signal.

17. The illumination source of claim 1, wherein the diffuser to further create a light beam having an intensity that varies from a leading edge of the light beam to a trailing edge of the light beam.

18. A display system comprising:
an illumination source, the illumination source comprising
a light source to produce colored light, and
a scanning optics unit optically coupled to the light source, the scanning optics unit configured to scan the colored light along a direction orthogonal to a light path of the illumination source, the scanning optics unit comprising
a diffuser to transform the colored light into beams of colored light,
a scan optics element positioned in the light path after the diffuser, the scan optics element to move the beams of colored light in the direction orthogonal to the light path, wherein distinct beams of colored light are separated by unilluminated space, and
a lens element positioned in the light path after the scan optics element, the lens element to convert an angular refraction of the beams of colored light into a spatial deflection;
a microdisplay optically coupled to the illumination source and positioned in a light path of the illumination source after the illumination source, the microdisplay configured to produce images by modulating light from the illumination source based on image data; and
a controller electronically coupled to the microdisplay and to the illumination source, the controller configured to control the scanning of the colored light, and to load image data into the microdisplay based on a position of the beams of colored light.

19. The display system of claim 18, wherein the scan optics element rotates about an axis of rotation and the axis of rotation is orthogonal to the light path.

20. The display system of claim 18, wherein the controller comprises:
a light pulsing processor configured to control light pulsing and intensity;
a light color processor coupled to the light pulsing controller, the light color processor configured to control light temperature control and white-point control; and
a microdisplay processor coupled to the light color processor, the microdisplay processor configured to load image data into the microdisplay based on the position of the scanned colored light.

21. The display system of claim 18, further comprising, a sensor electrically coupled to the controller and optically coupled to the illumination source, the sensor configured to convert light incident on a sensor surface into electrical information.

22. The display system of claim 21, wherein the sensor is a charge-coupled device or a CMOS image sensor.

23. A method of manufacturing a display system, the method comprising:
installing a light source configured to generate coherent light, wherein the light source installing comprises
installing a coherent light source to produce beams of colored light,
installing a diffuser in a light path of the coherent light source,
installing a scan optics element having facets arranged along an edge of the scan optics element in the light path of the coherent light source after the diffuser so that the light path of the coherent light source is incident to the edge and is orthogonal to the edge, the scan optics element to scan the beams of colored light with unilluminated space separating the beams of colored light,
installing a motor to rotate the scan optics element, and
installing a lens element in the light path after the scan optics element;
installing a microdisplay in a light path of the display system after the light source;
installing a controller configured to control the light source, the scan optics element, and the microdisplay; and
installing a display plane in the light path of the display system after the microdisplay.

24. The method of claim 23, wherein the installing of the scan optics element comprises installing a plurality of scan optics elements, each scan optics element having a separate motor.

25. The method of claim 23, wherein the scan optics element having an axis of rotation, and wherein the installing the scan optics element comprises installing the scan optics element so that the axis of rotation is orthogonal to the light path.

26. An illumination source comprising:
a light source to produce colored light; and
a scanning optics unit optically coupled to the light source, the scanning optics unit configured to scan the colored light along a direction orthogonal to a light path of the illumination source, the scanning optics unit comprising
a diffuser to transform the colored light into beams of colored light,
a scan optics element positioned in the light path after the diffuser, the scan optics element to move the beams of colored light in the direction orthogonal to the light path responsive to a modulated signal, and
a lens element positioned in the light path after the scan optics element, the lens element to convert an angular refraction of the beams of colored light into a spatial deflection.

27. The illumination source of claim 26, wherein the scan optics element comprises:
an optical material having an optical permittivity that changes with applied mechanical stress; and
a transducer coupled to the optical material, the transducer to convert electrical energy from the modulated signal into acoustical energy and to apply the acoustical energy to the optical material.

28. The illumination source of claim 26, wherein the scan optics element comprises:
a mirror positioned in the light path after the diffuser; and
a current sensor coupled to the mirror, the current sensor to move the mirror based on a current sensed from the modulated signal.
